(19) United States
(12) Patent Application Publication
(10) Pub. No.: US 2016/0098821 A1
(43) Pub. Date: Apr. 7, 2016

(54) IMAGE PROCESSING APPARATUS, DISPLAY APPARATUS, AND METHOD OF PROCESSING IMAGE THEREOF

(71) Applicant: SAMSUNG ELECTRONICS CO., LTD., Suwon-si (KR)

(72) Inventors: Cheon LEE, Yongin-si (KR); Jin-woo JEONG, Seoul (KR); Seung-hoon HAN, Suwon-si (KR)

(21) Appl. No.: 14/862,325

(22) Filed: Sep. 23, 2015

(30) Foreign Application Priority Data
Oct. 1, 2014 (KR) 10-2014-0132655

(51) Int. Cl. G06T 5/00

(52) U.S. Cl. CPC G06T 5/002; G06T 2207/10004; G06T 2207/20182

(57) ABSTRACT

A method of processing an image is provided. The method includes performing a noise filtering operation with respect to an input image, acquiring a differential image where an image to which the noise filtering operation is performed is excluded from the input image and removing a noise in a level higher than a predetermined level from the differential image, and acquiring an output image by adding the differential image from which the noise is removed and the image to which the noise filtering operation is performed.

### CROSS-REFERENCE TO RELATED APPLICATION

This application is based on and claims priority under 35 U.S.C. §119 to Korean Patent Application No. 10-2014-0132655, filed on Oct. 1, 2014 in the Korean Intellectual Property Office, the disclosure of which is incorporated herein by reference in its entirety.

### BACKGROUND

1. Field

The present disclosure generally relates to an image processing apparatus, a display apparatus, and a method of processing an image thereof, and more particularly, to an image processing apparatus which performs a noise filtering operation, a display apparatus, and a method of processing an image thereof.

2. Description of Related Art

With the development of electronic technologies, various types of electronic apparatuses have been developed and have come into wide use. Specially, a display apparatus, such as, a television (TV) which is commonly used in most households, has been developing rapidly over the last few years.

In addition, as the performance of a display apparatus has advanced, many studies are under progress to enhance an image quality of the display apparatus.

Generally, a method for removing a noise of an image includes a low-pass-filter such as a Gaussian filter, as a representative example. The low-pass-filter method may be easily implemented in view of its relatively low complexity. Such a low-pass filter removes noise of an image effectively. Accordingly, the method is widely used in various fields for image quality enhancement.

However, the low-pass-filter method has a problem in that it also simultaneously removes a fine original signal having a small variation and size in an image, thereby modifying the image excessively, resulting in lower or poorer image quality that may adversely affect user enjoyment.

### SUMMARY

The present disclosure is provided to address the aforementioned and other problems and disadvantages occurring in the related art, and an example aspect of the present disclosure provides an image processing apparatus which is capable of effectively removing noise while maintaining fine detail included in an image, a display apparatus, and a method of processing an image thereof.

According to an example embodiment, a method of processing an image is provided, the method including: performing a noise filtering operation with respect to an input image, acquiring a differential image where an image to which the noise filtering operation is performed is excluded from the input image and removing noise in a level higher than a predetermined level from the differential image, and acquiring an output image by adding the differential image from which the noise is removed and the image to which the noise filtering operation is performed.

Performing the noise filtering operation may include, for example, performing the noise filtering operation by applying an individual noise filtering strength based on a characteristic of each area of the input image.

Removing the noise in a level higher than the predetermined level may include, for example, removing noise in a level higher than the predetermined level by applying an inverse coring method to the differential image.

The differential image from which the noise is removed may, for example, be a differential image where a noise signal in a level higher than the predetermined level is removed and a fine detail signal is maintained.

The method may further include acquiring an image in which image quality is enhanced by applying an additional image quality enhancement operation to the image to which the noise filtering operation is performed. For example, the acquiring the output image may include acquiring an output image by adding the differential image from which the noise is removed and the image of which image quality is enhanced.

The method may further include acquiring a differential image in which image quality is enhanced by applying an additional image quality enhancement operation to a fine detail signal included in the differential image. In addition, acquiring the output image may include acquiring an output image by adding the differential image in which image quality is enhanced and the image to which the noise filtering operation is performed.

The additional image quality enhancement operation may, for example, include at least one of a definition enhancement operation, a noise enhancement operation, a contrast range enhancement operation, and a motion enhancement operation.

According to an example embodiment, an image processing apparatus is provided, including: a noise filtering unit configured to perform a noise filtering operation with respect to an input image, a differential image processor configured to acquire a differential image where an image to which the noise filtering operation is performed is excluded from the input image and remove a noise in a level higher than a predetermined level from the differential image, and an output image acquiring unit configured to acquire an output image by adding the differential image from which the noise is removed and the image to which the noise filtering operation is performed.

The noise filtering unit may, for example, perform the noise filtering operation by applying an individual noise filtering strength based on a characteristic of each area of the input image.

The differential image processor may, for example, remove a noise in a level higher than the predetermined level by applying an inverse coring method to the differential image.

The differential image from which the noise is removed may, for example, be a differential image where a noise signal in a level higher than the predetermined level is removed and a fine detail signal is maintained.

The image processing apparatus may further include a first enhancer configured to perform an additional image quality enhancement operation to the image to which the noise filtering operation is performed. In addition, the output image acquiring unit may acquire an output image by adding the differential image from which the noise is removed and the image of which image quality is enhanced.

The image processing apparatus may further include a second enhancer configured to acquire a differential image in which image quality is enhanced by applying an additional image quality enhancement operation to a fine detail signal included in the differential image. In addition, the output image acquiring unit may acquire an output image by adding the differential image of which image quality is enhanced and the image to which the noise filtering operation is performed.

The additional image quality enhancement operation may, for example, include at least one of a definition enhancement operation, a noise enhancement operation, a contrast range enhancement operation, and a motion enhancement operation.

According to an example embodiment, a display apparatus is provided including: a signal divider configured to divide a received signal into an audio signal and a video signal, an audio processor configured to provide signal-processing to the divided audio signal, a video processor configured to provide signal-processing to the divided video signal, and an output unit configured to output the processed audio signal and video signal. In addition, the video processor may perform a noise filtering operation with respect to the divided video signal, acquire a differential signal in which a signal to which the noise filtering operation is performed is excluded from the divided video signal, remove a noise in a level higher than a predetermined level from the differential signal, and acquire an output signal by adding the differential signal from which the noise is removed and the signal to which the noise filtering operation is performed.

The video processor may perform a noise filtering operation by, for example, applying an individual noise filtering strength based on a characteristic of each area of the video signal.

The video processor may remove a noise in a level higher the predetermined level by, for example, applying an inverse coring method to the differential signal.

The differential signal from which the noise is removed may, for example, be a differential signal where a noise signal in a level higher the predetermined level is removed and a fine detail signal is maintained.

According to various example embodiments, it is possible to acquire an image where a fine detail is maintained and a noise is removed.

### BRIEF DESCRIPTION OF THE DRAWINGS

The above and/or other aspects and advantages of the example embodiments of the present disclosure will be more apparent from the following detailed description taken in conjunction with the accompanying drawings, in which like reference numerals refer to like elements, and wherein:

FIG. 1 is a block diagram illustrating a structure of an image processing apparatus according to an example embodiment;

FIG. 2 is a block diagram illustrating a structure of an image processing apparatus according to another example embodiment;

FIGS. 3A and 3B are views provided to describe a structure of a display apparatus to which the image processing apparatus illustrated in FIG. 1 and FIG. 2 may be applied;

FIG. 4 is a view illustrating a filter for removing a noise in a level higher than a predetermined level from a differential image according to an example embodiment;

FIGS. 5 and 6A-6C are views provided to schematically describe a method of processing an image according to an example embodiment;

FIGS. 7A-7C are provided to describe a method of processing an image in a frequency domain according to an example embodiment; and

FIG. 8 is a flowchart provided to describe a method of processing an image according to an example embodiment.

### DETAILED DESCRIPTION

Example embodiments may be diversely modified. Accordingly, specific example embodiments are illustrated in the drawings and are described in detail herein. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used herein are only used to describe the example embodiments, but are not intended to limit the scope of the disclosure. The singular expression also includes the plural meaning as long as it does not conflict with the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the example embodiments, a “module” or a “unit” performs at least one function or operation, and may be implemented with hardware, software, or any combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, example embodiments will be described in detail with reference to the accompanying drawings.

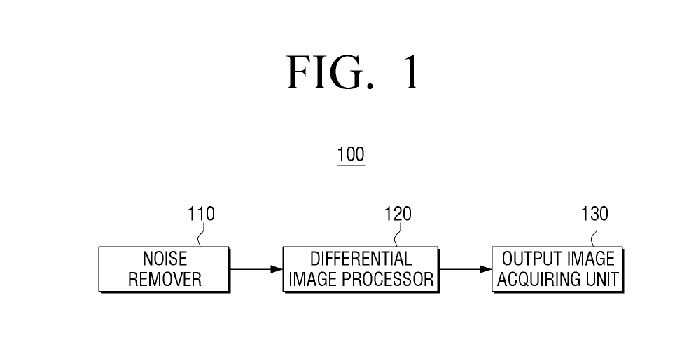

FIG. 1 is a block diagram illustrating a structure of an image processing apparatus according to an example embodiment. An image processing apparatus 100 illustrated in FIG. 1 may, for example, be realized as a software system or an image processing chip which is mounted to an image acquiring device such as a digital camera and a display apparatus such as a set-top box, a digital TV, etc.

Referring to FIG. 1, the image processing apparatus 100 according to an example embodiment includes a noise remover 110, a differential image processor 120, and an output image acquiring unit 130.

The noise remover 110 performs a noise filtering operation with respect to an input image to acquire an image from which noise has been removed.

In this case, the noise remover 110 may, for example, use a low-pass-filter in order to remove noise. Herein, the low-pass-filter may be realized in a manner or arranging a resistance (R) in serial and arranging a capacitor (C) in parallel in an operational amplifier, and passing a frequency band lower than a predetermined cutoff frequency and attenuating a frequency band higher than the predetermined cutoff frequency. For example, the low-pass-filter may include a filter for performing a least one of Gaussian filtering, median filtering, Laplacian filtering, or the like.

Specially, the noise remover 110 may analyze a characteristic of an image and apply an individual noise filtering strength for each area. For example, the noise remover 110 may apply a high noise filtering strength to an area having a large amount of noise and may apply a low noise filtering strength to an area having a large amount of detail.

The differential image processor 120 acquires a differential image where an image from which the noise is removed is excluded from an input image and removes noise in a level higher than a predetermined level.

Specifically, in response to the image from which the noise was removed being excluded from the input image, an image where a fine detail is maintained and the noise was removed may be acquired.

Subsequently to excluding an image from which noise is removed from an input image, the differential image processor 120 may remove noise in a level higher than a predetermined level from the differential image, that is, an image including a noise signal and a fine detail signal.

In this case, the differential image processor 120 may remove the noise in the level higher than the predetermined level by applying an inverse coring method to the differential image.

Accordingly, the image-processed differential image becomes an image including a noise signal in a level lower than the predetermined level and the fine detail signal.

The image acquiring unit 130 acquires an output image by adding the differential image from which the noise in the level higher than the predetermined level was removed, the differential image being output from the differential image processor 120, and the image output from the noise remover 110, for example, an image from which the noise was removed.

Specifically, the differential image output from the differential image processor 120 includes the noise signal in a level lower than the predetermined level and the fine detail signal, and the image output from the noise remover 110 includes the image from which the noise signal and the detailed signal were removed. Accordingly, in response to an output of the differential image processor 120 and an output of the noise remover 110 being added, it is possible to acquire an image where the fine detail signal is maintained and the noise in the level higher than the predetermined level was removed.

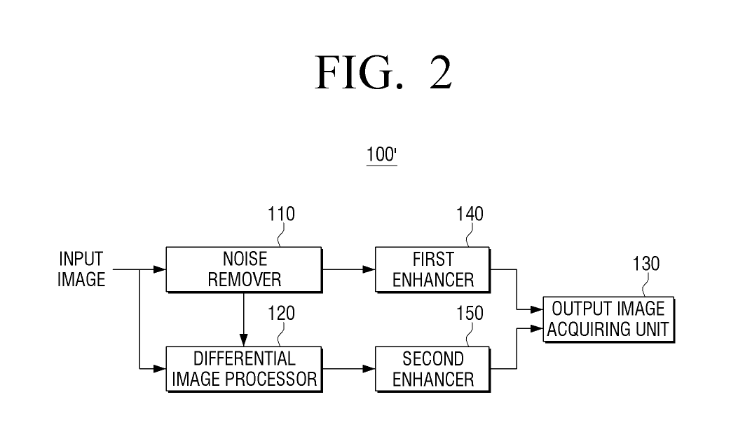

FIG. 2 is a block diagram illustrating a structure of an image processing apparatus according to another example embodiment.

Referring to FIG. 2, an image processing apparatus 100′ according to another exemplary embodiment includes the noise remover 110, the differential image processor 120, the output image acquiring unit 130, a first enhancer 140, and a second enhancer 150. Some of components in FIG. 2 are overlapped with the components illustrated in FIG. 1, and thus, the detailed description on the components is omitted.

The first enhancer 140 may perform an additional image quality enhancement operation with respect to an output of the noise remover 110.

Specifically, the first enhancer 140 may perform at least one of a definition enhancement operation, a noise enhancement operation, a contrast range enhancement operation, a motion enhancement operation, or the like.

For example, the first enhancer 140 may perform an image detail enhancement operation. In this case, the image detail enhancement may be an operation of extracting high frequency elements including image details, emphasizing the extracted high frequency elements, and adding the emphasized high frequency elements to an original image, thereby enhancing an image detail.

The second enhancer 150 may perform an additional image quality enhancement operation with respect to an output of the differential image processor 120.

Specifically, the second enhancer 150 may perform at least one of a definition enhancement operation, a noise enhancement operation, a contrast range enhancement operation, a motion enhancement operation, or the like.

For example, the second enhancer 150 may perform the definition enhancement operation with respect to a fine detail included in a differential image. Specifically, the second enhancer 150 may perform the definition enhancement operation by extracting high frequency elements corresponding to the fine detail included in the differential image, emphasizing the extracted high frequency elements, and adding the emphasized high frequency elements to an original image.

Meanwhile, in response to the additional image quality enhancement operation being performed by at least one of the first enhancer 140 and the second enhancer 150, the output image acquiring unit 130 may acquire an output image by adding the images to which the additional image quality enhancement operation was performed.

That is, the output image acquiring unit 130 may acquire an output image by adding an output of the first enhancer 140 and an output of the differential image processor 120, by adding an output of the noise remover 110 and an output of the second enhancer 150, or by adding the output of the first enhancer 140 and the output of the second enhancer 150.

In addition, the image processing apparatus 100′ may additionally apply various image processing methods such as a method of processing an image with more natural tone through, for example, ‘Flesh tone,’ ‘Natural color,’ and ‘dynamic moving picture control’ skills, a method of processing an image to be more clear by analyzing a brightness histogram of the image, emphasizing a relatively bright part, and darkening a relatively dark part, etc.

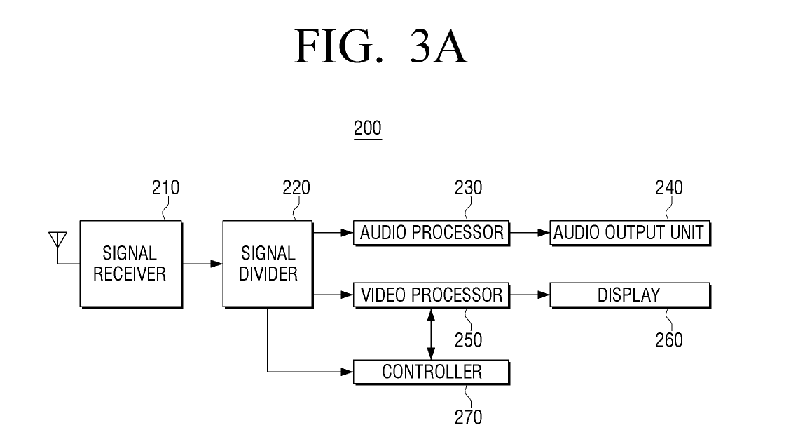

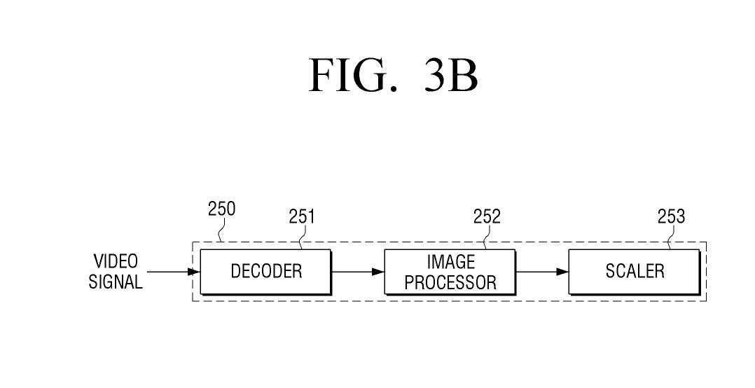

FIGS. 3A and 3B are views provided to describe a structure of a display apparatus to which the image processing apparatus illustrated in FIG. 1 and FIG. 2 may be applied.

FIG. 3A illustrates an example in which a display apparatus according to an example embodiment is realized as a digital TV. According to FIG. 3A, a display apparatus 200 includes a signal receiver 210, a signal divider 220, an audio processor 230, an audio output unit 240, a video processor 250, a display 260, and a controller 270.

The signal receiver 210 receives and demodulates, for example, any one of broadcasting signals received in a wireless and/or wired manner through the air or cable and other various input signals.

The signal divider 220 divides and outputs the signal received by the signal receiver 210 into an audio signal, a video signal, and additional data. The audio signal and video signal divided from the received signal are applied to the audio processor 230 and the video processor 250, respectively. The additional data is applied to the controller 290. The additional data may, for example, include program and system information protocol (PSIP) information.

The audio processor 230 decodes the audio signal output from the signal divider 220. In addition, the audio processor 230 converts the decoded audio signal into an audio signal in a format which may be output through a speaker of a TV.

The audio output unit 240 outputs the audio signal output from the audio processor 230 through the speaker.

The video processor 250 performs an image signal-processing operation, such as, video decoding, video scaling, etc., with respect to the video signal output from the signal divider 220. The structure of the video processor 250 will be described in further detail with reference to FIG. 3B.

FIG. 3B is a detailed block diagram illustrating a structure of the video processor 250 according to an example embodiment.

As illustrated in FIG. 3B, the video processor 250 may include a video decoder 251, an image processor 252, and a scaler 253.

The video decoder 251 decodes the video signal output from the signal divider 220. Accordingly, the video decoder 251 outputs an uncompressed video signal.

The image processor 252 performs various image processing operations with respect to the decoded video signal output from the video decoder 251. The image processing apparatus illustrated in FIGS. 1 and 2 may be realized as the image processor 252.

The scaler 253 scales a size of a video with respect to the image-processed video signal output from the image processor 252 to be suitable for the display 260.

The display 260 displays the video output from the video processor 250.

The controller 270 controls overall operations of the above described components. Specifically, according to various example embodiments, the controller 290 may control the operations performed by the image processor 252. The operations of the image processor 252 were described above with reference to FIGS. 1 and 2, and thus, the overlapped description is omitted.

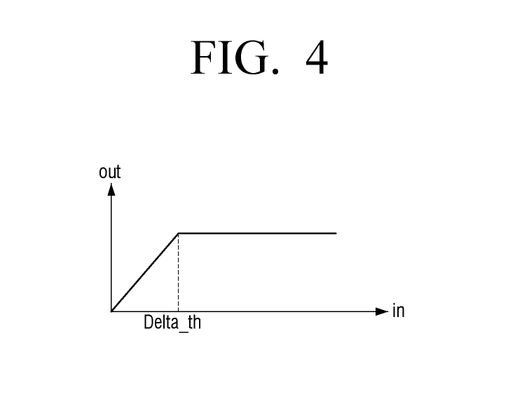

FIG. 4 is a view illustrating a filter for removing a noise in a level higher than a predetermined level from a differential image according to an example embodiment.

By using a filter having the characteristics illustrated in FIG. 4, a noise in a level higher than the predetermined level from among the noise included in the differential image may be removed. That is, the noise having a level higher than the predetermined level from among the noise included in the differential image may be removed by outputting noise in the predetermined level as a constant value through the filter. In this case, for example, a Delta_th value may be set to be a threshold value which is greater than a fine detail and smaller than a noise included in the differential image. Accordingly, a noise greater than the Delta_th value is removed, and only a noise smaller than the Delta_th value remains.

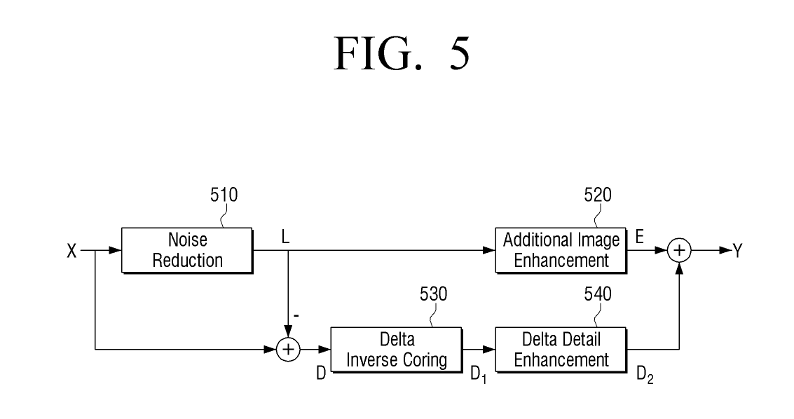

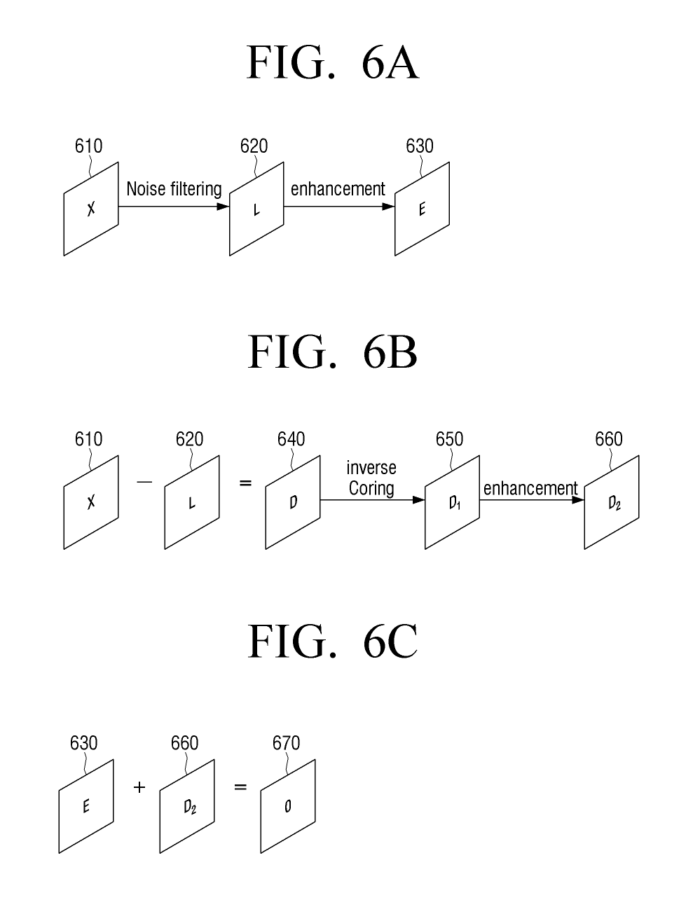

FIGS. 5 and 6A-6C are views provided to schematically describe a method of processing an image according to an example embodiment.

As illustrated in FIG. 5, an input image X may be output as an image E from which noise was removed and image quality was enhanced by passing through a Noise reduction block 510 and an Additional image enhancement block 520.

Specifically, as illustrated in FIG. 6A, an image L 620 from which noise was removed may be acquired by applying the noise filtering operation to the input image X 610, and an image E 630 for which image quality was enhanced may be acquired by applying the image quality enhancement operation to the image L 620 from which noise was removed. In this case, the image quality enhancement operation may be the defined quality enhancement operation, but is not limited thereto. That is, the image quality enhancement operation may include various image quality enhancement methods.

In addition, a differential image D in which the image L from which noise was removed is excluded from the input image X may be output as an image D2 where the noise in the level higher than the predetermined level was removed and definition of a detail was enhanced, by passing through a Delta inverse coring block 530 and a Delta detail enhancement block 540.

Specifically, as illustrated in FIG. 6B, a differential image D1 650 from which the noise in a level higher than the predetermined level was removed may be acquired by performing an inverse coring operation with respect to a differential image D 640 where the image L 620 from which the noise was removed is excluded from the input image X 610, and a differential image D2 660 for which image quality was enhanced may be acquired by applying the image quality enhancement operation to the acquired differential image D1 650. In this case, the image quality enhancement operation may be an operation of appropriately enhancing the definition of the detail, but is not limited thereto. That is, the image quality enhancement operation may include various image quality enhancement methods.

Subsequently, an output image may be acquired by adding the image E and the differential image D2.

Specifically, as illustrated in FIG. 6C, an output image 0 670 may be acquired by adding the image E 630 where the noise was removed and the image quality was enhanced and the differential image D2 660 where the detail definition was enhanced.

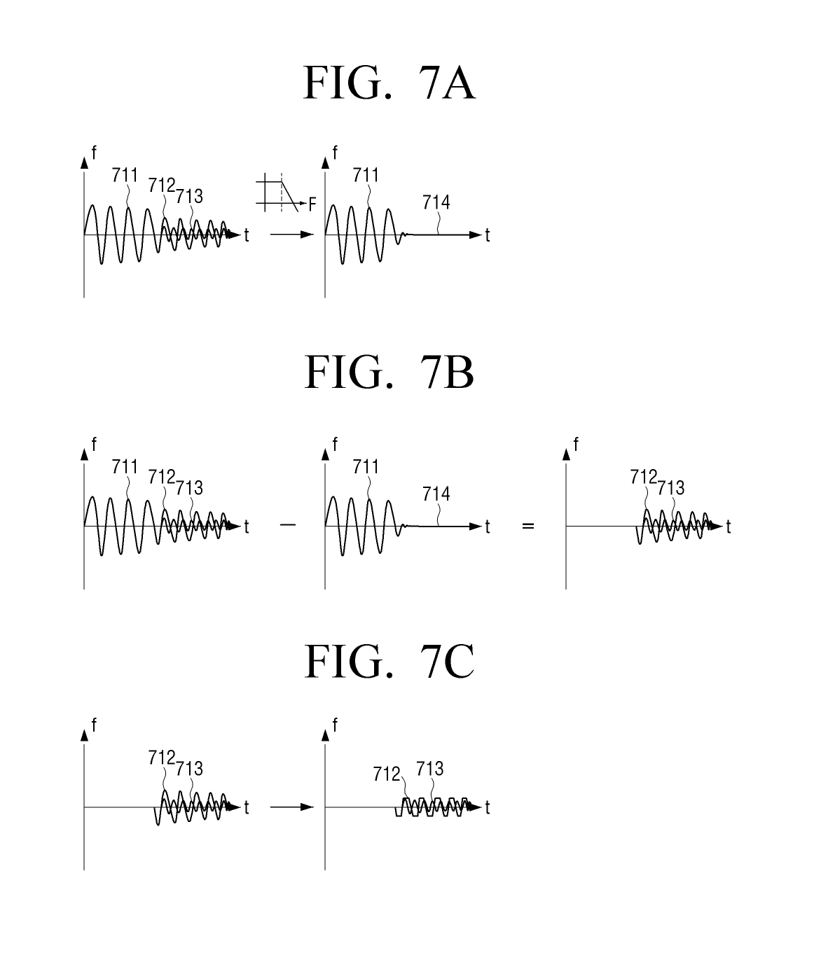

FIGS. 7A-7C are views provided to describe a method of processing an image in a frequency domain according to an example embodiment.

As illustrated in FIG. 7A, the high frequency elements of an input image signal 711 may include a detail signal 713 as well as a noise signal 712. In response to the high frequency elements being removed by applying a noise removal filter to the image signal 711, the detail signal 713 may be removed as well as the noise signal 712.

Meanwhile, as illustrated in FIG. 7B, a differential image signal where a signal from which the noise calculated in FIG. 7A was removed is excluded from the input image signal 711 includes both of the noise signal 712 and the detail signal 713. In addition, as illustrated in FIG. 7C, in response to the inverse coring operation of removing the noise in the level higher than the predetermined level being performed, a signal including a noise in the level lower than the predetermined level and a detail signal may be acquired.

Subsequently, in response to the acquired signal of FIG. 7A and the acquired signal of the FIG. 7C being added, an image signal where the noise in the level higher than the predetermined level was removed and the detail signal is maintained may be acquired.

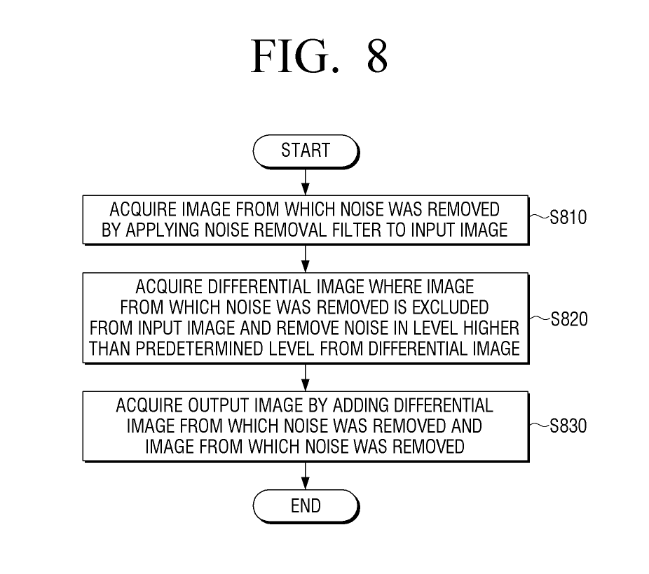

FIG. 8 is a flowchart provided to describe a method of processing an image according to an example embodiment.

According to an example method of processing an image in FIG. 8, a noise filtering operation is performed with respect to an input image (S810).

Subsequently, a differential image where the image to which the noise filtering operation was performed is excluded from the input image is acquired, and a noise in a level higher than a predetermined level is removed from the differential image (S820). In this case, the acquired differential image may be a differential image where a noise signal in the level higher than the predetermined level was removed and a fine detail signal is maintained.

Subsequently, an output image is acquired by adding the differential image from which the noise was removed, the differential image being acquired at S820, and the image to which the noise filtering operation was performed, the image being acquired at S810 (S830).

In addition, at S810 where the noise filtering operation is performed, the noise filtering operation may, for example, be performed by applying an individual noise filtering strength based on a characteristic on each area of an input image.

At S820 where the noise in the level higher than the predetermined level, the noise in the level higher than the predetermined level may, for example, be removed by applying the inverse coring method to the differential image.

The method of processing an image may further include acquiring an image of which image quality was enhanced by applying an additional image quality enhancement operation to the image to which the noise filtering operation was performed, and at S830, an output image may be acquired by adding the differential image from which the noise was removed, the differential image being acquired at S820, and the image of which image quality was enhanced.

In addition, the method of processing an image may further include acquiring a differential image in which image quality was enhanced by applying the additional image quality enhancement operation to a fine detail signal included in the differential image, and at S830, an output image may be acquired by adding the differential image in which image quality was enhanced and the image to which the noise filtering operation was performed, the image being acquired at S810.

In this case, the additional image quality enhancement operation may include at least one of the definition enhancement operation, the noise enhancement operation, the contrast range enhancement operation, the motion enhancement operation, or the like.

According to above described various example embodiments, an image where a fine detail is substantially maintained and a noise was reduced and/or removed may be acquired.

The method of processing an image according to above described various example embodiments may be realized as a program and provided to an image processing apparatus or a display apparatus.

As an example, a non-transitory computer readable medium including a program which performs operations of acquiring an image from which a noise was removed by applying a noise removal filter to an input image, acquiring a differential image where the image from which the noise was removed is excluded from the input image, removing a noise in a level higher than a predetermined level from the differential image, and acquiring an output image by adding the differential image from which the noise was removed and the image from which the noise was removed may be provided.

The method of processing an image according to various exemplary embodiments described above may be implemented in a program so as to be provided to the display apparatus. Particularly, the program including the method of processing an image may be stored and provided in a non-transitory computer readable medium.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like. As described above, and will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a rea-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

Hereinabove, although the example embodiments of the present disclosure have been shown and described, it should be understood that the present disclosure is not limited to the disclosed embodiments and may be variously changed by those skilled in the art without departing from the spirit and the scope of the present disclosure. Therefore, the present disclosure should be construed as including all the changes, equivalents, and substitutions included in the spirit and scope of the present disclosure.

What is claimed is:

1. A method of processing an image, comprising:
performing a noise filtering operation with respect to an input image;
generating a differential image wherein an image to which the noise filtering operation is performed is excluded from the input image and a noise in a level higher than a predetermined level is removed from the differential image; and
generating an output image by adding the differential image and the image to which the noise filtering operation is performed.

2. The method as claimed in claim 1, wherein performing the noise filtering operation comprises performing the noise filtering operation by applying a noise filtering strength to each area of the input image based on a characteristic of each area of the input image.

3. The method as claimed in claim 1, wherein removing the noise in a level higher than the predetermined level comprises removing noise in a level higher than the predetermined level by applying inverse coring to the differential image.

4. The method as claimed in claim 1, wherein the differential image from which the noise is removed is a differential image in which a noise signal in a level higher than the predetermined level is removed and a fine detail signal is maintained.

5. The method as claimed in claim 1, further comprising:
generating an image having enhanced image quality by applying an additional image quality enhancement operation to the image to which the noise filtering operation is performed,
wherein the generating the output image comprises acquiring an output image by adding the differential image from which the noise is removed and the image having enhanced image quality.

6. The method as claimed in claim 1, further comprising:
generating a differential image in which image quality is enhanced by applying an additional image quality enhancement operation to a fine detailed signal included in the differential image,
wherein generating the output image comprises generating an output image by adding the differential image for which image quality is enhanced and the image to which the noise filtering operation is performed.

7. The method as claimed in claim 5, wherein the additional image quality enhancement operation comprises at least one of a definition enhancement operation, a noise enhancement operation, a contrast range enhancement operation, and a motion enhancement operation.

8. An image processing apparatus comprising:
a noise filter configured to perform a noise filtering operation with respect to an input image;
a differential image processor configured to acquire a differential image where an image to which the noise filtering operation is applied is excluded from the input image and to remove a noise in a level higher than a predetermined level from the differential image; and
an output configured to generate an output image by adding the differential image from which the noise is removed and the image to which the noise filtering operation is performed.

9. The image processing apparatus as claimed in claim 8, wherein the noise filter performs noise filtering by applying a noise filtering strength to each area of the input image based on a characteristic of each area of the input image.

10. The image processing apparatus as claimed in claim 8, wherein the differential image processor removes noise in a level higher than the predetermined level by applying inverse coring to the differential image.

11. The image processing apparatus as claimed in claim 8, wherein the differential image from which the noise is removed is a differential image in which a noise signal in a level higher than the predetermined level is removed and a fine detail signal is maintained.

12. The image processing apparatus as claimed in claim 8, further comprising:
first enhancer processing circuitry configured to perform an additional image quality enhancement operation on the image to which the noise filtering operation is performed,
wherein the output generates an output image by adding the differential image from which the noise is removed and the image of which image quality is enhanced.

13. The image processing apparatus as claimed in claim 8, further comprising:
second enhancer processing circuitry configured to generate a differential image for which image quality is enhanced by applying an additional image quality enhancement operation to a fine detailed signal included in the differential image,
wherein the output image circuitry generates an output image by adding the differential image for which image quality is enhanced and the image to which the noise filtering operation is performed.

14. The image processing apparatus as claimed in claim 12, wherein the additional image quality enhancement operation comprises at least one of a definition enhancement operation, a noise enhancement operation, a contrast range enhancement operation, and a motion enhancement operation.

15. A display apparatus comprising:
a signal divider configured to divide a received signal into an audio signal and a video signal;
an audio processor configured to apply signal processing to the divided audio signal;
a video processor configured to apply signal processing to the divided video signal; and
an output configured to output the processed audio signal and video signal,
wherein the video processor is configured to perform a noise filtering operation with respect to the divided video signal, acquire a differential signal where a signal to which the noise filtering operation is performed is excluded from the divided video signal, remove noise in a level higher than a predetermined level from the differential signal, and generate an output signal by adding the differential signal from which the noise is removed and the signal to which the noise filtering operation is performed.

16. The display apparatus as claimed in claim 15, wherein the video processor is configured to perform a noise filtering operation by applying a noise filtering strength to each area of the video signal based on a characteristic of each area of the video signal.

17. The display apparatus as claimed in claim 15, wherein the video processor is configured to remove a noise in a level higher than the predetermined level by applying inverse coring to the differential signal.

18. The display apparatus as claimed in claim 15, wherein the differential signal from which the noise is removed is a differential signal in which a noise signal in a level higher the predetermined level is removed and a fine detail signal is maintained.
